(19) United States
(12) Patent Application Publication
(10) Pub. No.: US 2025/0237562 A1
(43) Pub. Date: Jul. 24, 2025

(54) Temperature Error Detection At One End Of A Cable Connection Far From The Temperature Sensor By Temperature Gradient Observation

(71) Applicant: Schaeffler Technologies AG & Co. KG, Herzogenaurach (DE)

(72) Inventor: Christian Reichinger, Neutraubling (DE)

(73) Assignee: Schaeffler Technologies AG & Co. KG, Herzogenaurach (DE)

(21) Appl. No.: 19/177,033

(22) Filed: Apr. 11, 2025

Related U.S. Application Data
(63) Continuation-in-part of application No. PCT/EP2023/077978, filed on Oct. 10, 2023.

(30) Foreign Application Priority Data
Oct. 13, 2022 (DE) 10 2022 210 821.3

(51) Int. Cl. G01K 15/00; B60L 53/16; G01K 3/10; H01R 13/66

(52) U.S. Cl. CPC G01K 15/007; B60L 53/16; G01K 3/10; H01R 13/6683

(57) ABSTRACT

A first plug connection at a first end of a cable connection is monitored by sensing the temperature at a second end of a cable connection by a temperature sensor. This is located in a first plug element to which the second end is connected, or is located in a second plug element inserted into the first plug element. The temporal temperature gradient is determined from the temporal course of the recorded temperature. The temperature gradient is compared with a threshold value. A temperature error signal is emitted for the first connection when the threshold is exceeded. Furthermore, a corresponding error detection unit is described.

### CROSS-REFERENCE TO RELATED APPLICATIONS

This application claims the benefit of PCT Application PCT/EP2023/077978, filed Oct. 10, 2023, which claims priority to German Application 10 2022 210 821.3, filed Oct. 13, 2022. The disclosures of the above applications are incorporated herein by reference.

### TECHNICAL FIELD

The disclosure relates to a temperature error detection at one end of a cable connection far from the temperature sensor by temperature gradient observation.

### BACKGROUND

Vehicles with electric drives have an on-board electrical system in which high currents flow and high voltages prevail to be able to provide the required high performance values. High outputs are required, especially for charging processes, to keep the charging process as short as possible. Like any ohmic conductor, power losses occur in the copper cables used, which increase the temperature. When charging, a charging cable can be plugged into a charging socket of a vehicle, whereby the charging current is transmitted within the vehicle via a cable connection. Since the vehicle is exposed to vibrations and plug connections can become loose as a result, increased contact resistances can occur at plug connections even at cable connections within the vehicle.

### SUMMARY

To increase safety, to the disclosure provides a way of detecting increased contact resistances by way of temperature events.

It is proposed to monitor the temperature of a cable that runs through the vehicle, for example between a charging socket of a vehicle and a high-voltage component of the vehicle. For this purpose, the temperature curve is used, which is determined by a temperature sensor in the charging socket. If the temporal change in temperature is above a threshold value, i.e. if the temporal temperature gradient is above a threshold value, then a contact point error can be detected at the opposite end of the cable connection. This allows the contact point at a first end of the cable connection, which exists between a high-voltage component and the cable connection, to be monitored by a sensor located on a plug connection at the opposite end of the cable connection, especially at a charging socket. This means that temperature sensors, which are already present on the charging socket, can also be used to monitor contact points that are located at the opposite end of the cable connection leading to the charging socket.

A method for monitoring a first plug connection is therefore proposed. The monitoring refers to the contact resistance and the associated temperatures in the event of error (high) contact resistance. The first plug connection is located at the first end of a cable connection. The first end of the cable connection leads to a high-voltage component within the vehicle or is provided for within it. The first plug connection is thus used for the (in-vehicle) connection of the high-voltage component or within the high-voltage component. The cable connection is used to connect the high-voltage component to a charging socket or, in general, to a first plug element, which is located in an outer shell of the vehicle or in a high-voltage component.

It is intended to detect the temperature at the second end of the cable connection that is opposite to the first end of the cable connection (where the first plug connection to be monitored is located). The temperature sensor can be located in the first plug element to which the second end of the cable connection is connected, for example in a charging socket of the vehicle. Alternatively, the temperature sensor can be located in a second plug element that is plugged into the second plug element, such as a charging plug from an external charging connection or an external charging station. The temperature sensor is thermally connected to the first end, such as to a first plug element connected to the cable connection there, or to a second plug element connected to the first plug element by insertion (or screwing). Plug elements or plug connections are pure plug-in elements or plug-in connections as well as screw fasteners and screw connections that are not only plugged in but also secured by screw windings. Since both plug-in connections and screw connections are based on a first element that is inserted into a second element and differ only in the type of securing (adhesive force in the case of pure plugs or positive connection due to screw coils in the case of screw elements), both connection designs are referred to as plug-in connections or plug elements. Alternatively, the plug-in connections can also be referred to as plug-in or screw connections and plug elements can also be referred to as plug-in or screw elements.

It is intended to determine the temporal temperature gradient from the temporal course of the recorded temperature or a recorded temperature value. The temperature sensor thus emits a temperature value, whereby the strength of the temporal change, i.e. the temporal temperature gradient, is determined in accordance with the procedure. For example, the temperature gradient corresponds to the temporal course of the temperature value supplied by the temperature sensor, derived from time.

The temperature gradient or the strength recorded in this way for the temporal change of the temperature value is compared with a threshold value. A temperature error signal is emitted for the first plug connection when the threshold is exceeded. If the threshold value is not exceeded, then the temperature error signal for the first plug connection is not emitted. The temperature error signal for the first plug connection indicates that the temperature in the first plug connection (opposite to the second plug connection where the temperature sensor is located) is rising too rapidly in an erroneous manner, and this is considered a signal of a contact error in the first plug connection. The temperature error signal thus indicates that there is an error in the first plug connection that is causing this temperature rise (measured at the opposite end).

In some examples, temperature monitoring is also carried out for a plug connection at the second end, i.e. at a plug connection on which the temperature sensor is located. Here, the temperature detected by the temperature sensor is compared with an upper temperature limit, and if exceeded, a temperature error signal is emitted for the respective plug connection (opposite to the first plug connection). In some examples, the same unit will carry out temperature monitoring for both the first plug connection and the opposite second plug connection. In some examples, the same unit will both compare the temperature gradient with the threshold value in order to emit a first temperature error signal when exceeded, and compare the temperature detected by the temperature sensor with a temperature upper limit in order to emit another temperature error signal for the second plug connection (opposite to the first plug connection). Therefore, an error detection unit is connected to the temperature sensor and is designed as such a unit. The error detection unit is set up to compare the temperature gradient with the threshold value and, if exceeded, to emit the temperature error signal for the first plug connection when it is exceeded, as well as to compare the temperature detected by the temperature sensor with a temperature upper limit and to emit another temperature error signal for the second plug connection if it is exceeded. With this, the error detection unit monitors both the plug connection where the temperature sensor is located and the (first) plug connection located at the opposite end of the cable connection. If the upper temperature limit or threshold value is not exceeded, then no temperature error signal is emitted. If the temperature gradient does not exceed the threshold value, the first temperature error signal, i.e. the temperature error signal for the first plug connection, is not emitted. If the temperature detected by the temperature sensor does not exceed the upper temperature limit, then no temperature error signal is emitted for the second plug connection. The temperature error signal for the second plug connection can also be referred to as another temperature error signal.

The first plug element may be an electric vehicle charging socket that is embedded in a vehicle outer shell. The electric vehicle charging socket may be accessible from the outside, for example via a lockable or locking flap. In some examples, the charging socket can be designed in accordance with a standard for the design of wired charging plug elements. The second plug element, in which the temperature sensor is alternatively located, can be an electric vehicle charging plug, such as a charging plug designed according to a standard for the design of plugs for conductive charging of electric vehicles.

The first plug connection, which is monitored by the temperature gradient analysis, can have two plug elements that are plugged into each other. These plug elements can be referred to as the third and fourth plug element and are located at the first end of the cable connection, i.e. opposite to the end where the temperature sensor is located. The third plug element is connected directly to the first end of the cable connection. The fourth plug element is part of a high-voltage component and is intended in an outer casing of a high-voltage component within the vehicle. The high-voltage component can be, for example, a high-voltage box, a high-voltage distributor or a junction box that forwards and distributes high-voltage potentials that can be switched or not. The third plug element can be designed as a high-voltage socket. The fourth plug element is designed to complement this and is a high-voltage plug. The fourth plug element is located at the first end of the cable connection. The high-voltage component includes an on-board charging device, such as a DC charging device for outputs of more than 11 kW, more than 50 kW or more than 100 kW. The high-voltage component can have a housing that completely encloses the inside of the high-voltage component. The third plug element can be embedded in the housing, thus enabling an electrical connection, but avoiding direct access due to the housing. The third and fourth plug elements are designed to complement each other, whereby the third plug element can also be designed as a plug and the fourth plug element can also be designed as a socket. The third and fourth plug elements may be locked together.

In some implementations, the second end of the cable connection is connected to contacts of the first plug element without a plug-in connection. For example, the cable connection may protrude from the first plug element (charging socket), whereby the contacts of the first plug element are connected to the wires of the cable connection without another plug connection, for example by soldering, welding and/or pressing. Alternatively, a second plug connection can be provided, which is connected to the contacts of the first plug element. Such a second plug connection has two further plug elements, one of which is connected to the wires or wires of the cable connection at its second end, and another plug element of the second plug connection is plugged into the fifth plug element. The sixth plug element can be part of a connection module or a charging socket module, which also includes the first plug element (charging socket). The first plug element (charging socket) and the sixth plug element are connected to each other within the module, such as plug-free. The first plug element is arranged on one outside (on a vehicle outer shell), while the sixth plug element faces inwards and is arranged on an inside of the vehicle shell. The fifth plug element can be plugged in directly for this purpose in order to connect the second end of the cable connection to the first plug element via the sixth plug element. This allows for easy replacement of the charging socket without replacing the cable connection. In other words, a cable may protrude from the device containing the first plug element (charging socket) which forms the cable connection in order to connect it to the high-voltage component via the first plug connection, or a charging socket device may be provided which, on the one hand, includes the charging socket as the first plug element and, on the other hand, includes the sixth plug element as a further plug element, whereby within the module these two plug elements are electrically connected to each other in order to enable a plug-in connection to the cable connection on one side opposite to the first plug element by way of the sixth plug element.

It also describes an error detection unit that has a temperature sensor input. The error detection unit has a gradient former. The gradient former is downstream of the temperature sensor input. The gradient former is set up to determine the stronger temporal change (temporal temperature curve derived from time) of the temperature value applied to the temperature sensor input. The error detection unit also has a gradient comparator. This is downstream of the gradient former and is set up to compare the strength of the temporal change with a threshold value. The gradient former is also set up to emit a temperature error signal when the threshold value is exceeded. The gradient former is also set up not to emit a temperature error signal if the threshold value is not exceeded. The temperature error signal refers to a plug connection or a temperature increase at one end of a cable connection that is opposite to the end where the temperature sensor is located, which can be connected to the temperature sensor input. This allows the error detection unit to detect an error via the gradient that is located at one end of a cable connection opposite to the temperature sensor. The temperature error signal therefore does not refer to the location where the temperature sensor is located, but to a location connected to it via a cable connection.

Finally, the error detection unit can have a temperature comparator. This is downstream of the temperature sensor input. The temperature comparison is set up to compare the temperature detected by the temperature sensor with a temperature upper limit to emit another temperature error signal if the temperature upper limit is exceeded. If the upper temperature limit is not exceeded, then the further temperature error signal is not emitted. As a result, the error detection unit also has the function of detecting a temperature increase caused by an error to the location where the temperature sensor is located.

Furthermore, the procedure can affect plug-in or screw connections (short: plug connection) and plug or screw elements (short: plug elements) within a high-voltage component such as a high-voltage junction box. Such a procedure is used to monitor a first plug connection that is provided for in the high-voltage component. The first plug connection is located at the first end of a cable connection that is provided within the high-voltage component. The temperature at a second end of the cable connection is detected. The second end is also located inside the high-voltage component. The temperature is recorded by way of a temperature sensor, which is located in a first plug element or is thermally connected to it. The second end is connected to the first plug element. In some examples, the temperature sensor can be located in a second plug element that is plugged into the first plug element. The second plug element is located in the high-voltage component. In some examples, the indication “in the high-voltage component” means “within a space that is completely enclosed by a housing of the high-voltage component”. Furthermore, as already described, the temporal temperature gradient is determined from the temporal course of the recorded temperature. The temperature gradient is compared with a threshold value. A temperature error signal is emitted for the first plug connection when the threshold is exceeded.

In some implementations, the first plug element on which the temperature sensor is provided is a plug element at a junction within a high-voltage component. The plug connection (first plug connection) that is monitored is also located inside the high-voltage component or inside the housing of the high-voltage component.

The first plug element in the high-voltage component has been replaced by a screw connection with a temperature sensor, such as for reasons of functional safety. The first plug element and the second first plug element can be screwed together. This ensures that the temperature sensor in one of the plug elements is also thermally connected to the remaining cable connection.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows an exemplary procedure and an exemplary error detection unit.

FIG. 2 shows a further exemplary procedure and an exemplary error detection unit.

Like reference symbols in the various drawings indicate like elements.

### DETAILED DESCRIPTION

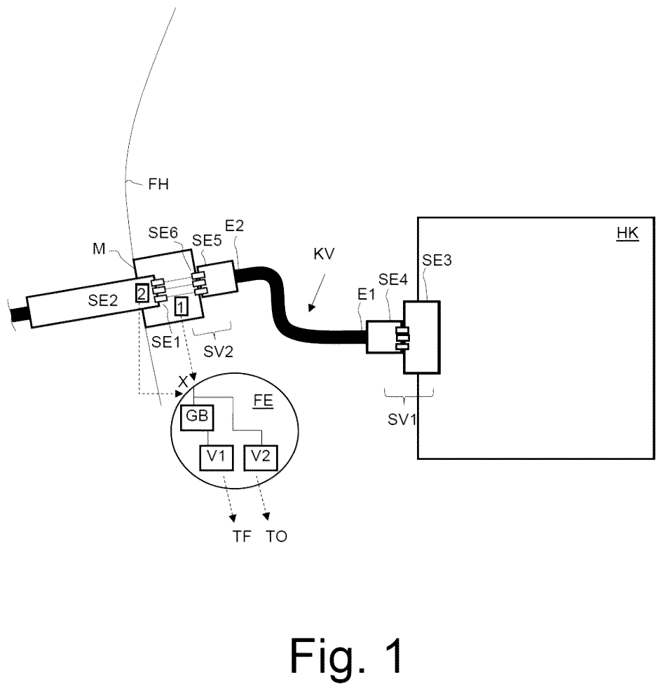

FIG. 1 shows a vehicle outer shell FH to which a first plug element SE1 is attached. The plug element SE1 is directed outwards and connected to a second plug element SE2 that is plugged in from the outside. Inside the vehicle, a high-voltage component HK is planned, such as a high-voltage box or another junction unit for high-voltage potentials. A cable connection KV connects the first plug element SE1 with the high-voltage component, which can include a charging circuit, for example. In this way, charging power can be transmitted to the first plug element SE1 via the second plug element SE2, whereby the charging power is still transmitted via the cable connection KV to the high-voltage component HK.

A first plug connection SV1 is provided at a first end of the cable connection KV. The first plug connection, SV1, connects the cable connection to the high-voltage component. At the second, opposite end E2 of the cable connection, it is connected to the first plug element SE1. A connector-based connection is shown, but at this point a connector-free connection between the second end E2 of the cable connection KV and the first plug element SE1 can also be provided. The first plug element may be designed as a charging socket and has a temperature sensor 1. If there is a contact error at the first end E1 at the first plug connection SV1 (i.e. at the opposite end where the first plug element is located), which leads to an increased contact resistance, then the first plug connection SV heats up. A third plug element SE3 or a fourth plug element SE4 plugged into it can heat up. The plug connection SV1 is located at the first end E1 of the plug elements SE3 and SE4, whereby the cable connection also transmits the increased temperature (caused by a contact error in SV1) to the second end E2 and thus also to the first plug element SE1 due to its electrical properties. A temperature sensor 1 in the first plug element or a temperature sensor 2 in the second plug element SE2, which is plugged into each other with the first plug element SE1, receives the heat originating from SV1. It can therefore be determined on the basis of the temporal temperature gradient of the temperature sensors 1 or 2 if excessive heat is generated at the opposite end E1 due to a contact error, or the temperature increases there.

An error detection unit FE is downstream of the first temperature sensor 1. If there is a temperature sensor 2 in the plug element SE2, then this temperature sensor is also upstream of the error detection unit FE. The error detection unit FE has a temperature sensor input X, to which the relevant temperature sensor 1 or 2 or both sensors, 1.2, are connected. The error detection unit FE has a gradient former GB, which detects the strength of the change in time of the temperature signal emitted by sensors 1 and/or 2. The gradient former is followed by a first comparator V1, which compares the strength of the temporal change or the gradient (or a quantity that reflects it) with a threshold value. If the strength of the temporal change or the temperature gradient is above the threshold value, then a temperature error signal TF is emitted by the gradient former or by the error detection unit FE. The temperature error signal TF indicates that there is a contact error in the plug connection SV1, for example in the plug elements SE3 and/or SE4. As shown, the error detection unit also has a second comparator V2, which compares the temperature signal of sensors 1 and/or 2 with an upper temperature limit. If this upper temperature limit is exceeded, an error signal TO is emitted, which indicates that there is an increased temperature at the plug element SE1 or at the plug element SE2. The error signals thus reflect increased temperatures or contact errors at different ends E1 and E2 of the cable connection KV, such as at different plug elements SE1 or SE2 on the one hand or at the plug connection SV1 on the other. The error TF refers to contact errors in the plug connection SV1 (that is, in the plug elements SE4 or SE3). The error TO indicates an increased temperature at the plug elements SE1 or SE2.

Shown is a connector module M, in which the first plug element SE1 (i.e. the charging socket) is located. In addition, FIG. 1 shows a variant in which this module M has a plug element SE6, which is plugged into each other with the plug element SE5. Since this connection is provided between the second end E2 of the cable connection KV via the plug elements SE5 and SE6. The fifth plug element SE5 is connected directly (without connectors) to the second end E2. The sixth plug element SE6 (part of module M) is connected directly (without plug-in connection) to the plug element SE1. These direct connections can be made, for example, by soldering, welding and/or pressing. The connection between the end E1 and the plug element SE4 is also a direct connection, which is designed in the same way.

A variant that deviates from this provides that the second end E2 of the cable connection KV is not connected to the first plug element SE1 via the plug elements SE5 and SE6, but is connected directly to the plug element SE1. In this case, the second end E2 of the cable connection KV extends to the first plug element SE4 and is directly connected to it. Module M then has the first plug element SE1, while the second end of the cable connection KV within the module is connected to the plug element SE1 and the cable connection extends from module M to the plug element SE4 or to the high-voltage component HK. Such a module dispenses with the SE5 and SE6 plug elements and the associated additional plug connection. Instead, there is a direct connection between the Cable connection KV and the plug element SE1, i.e. a connection without connectors.

The device of FIG. 1 can be used to monitor the first plug connection SV1, which is located at the first end El of the cable connection KV. The temperature is measured at the second end of the cable connection by way of a temperature sensor (at points 1 or 2). The temperature sensor is located on the first plug element SE1, i.e. within the first plug element or on its contacts, or is located on the second plug element SE2 (a charging plug that is also connected to the first plug element SE1 for heat transfer due to the plugged in connection). The temperature sensor can therefore be located in the first plug element and/or in the second plug element (SE1, SE2).

The temporal temperature gradient, i.e. the strength of the temperature change or temperature increase, is determined from the course of the temperature recorded in this way. The temperature gradient recorded in this way, or the quantity recorded in this way, which reflects the strength of the temperature increase at the temperature sensor, is compared with a threshold value. The threshold value is predefined and is based, for example, on the cable length of the cable connection or on its thermal resistance between E1 and E2. A temperature error signal is then emitted when the threshold value is exceeded, whereby this temperature error signal TF is linked to the first plug element. The temperature error signal TF indicates that the first plug element is heating up. The error signal TO, on the other hand, can indicate that there is an increased temperature at the first plug element SE1 or at the second plug element SE2. By looking at the instantaneous value of the temperature (compared to an upper temperature limit) and by looking at the temperature gradient, temperature errors can be detected at different ends E1, E2 of the cable connection. In other words, the temperature error signal TF indicates that there is an increase in temperature or a high temperature at the first end E1 of the cable connection, while the temperature error signal TO indicates that an increased temperature has been measured at the second end E2 of the cable connection KV (which is above a temperature upper limit).

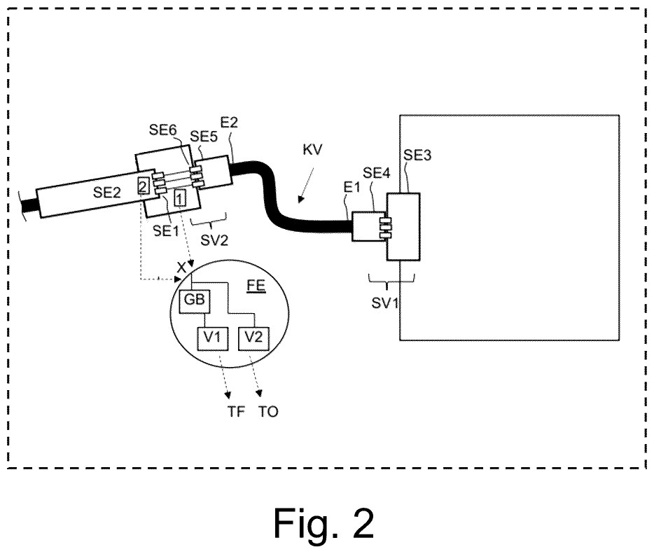

FIG. 2 shows a device with an error detection unit FE, with a first plug connection SV1, with a cable connection KV having a first end E1 and a second end E2, and with a temperature sensor 1, 2.

The device of FIG. 2 can be used to monitor the first plug connection SV1, which is located at the first end El of the cable connection KV. The temperature is measured at the second end of the cable connection by way of a temperature sensor (at points 1 or 2).

The temperature sensor 1 is located in a first connection element SE1 to which the second end E2 of the cable connection KV is connected. Alternatively, the temperature sensor 1 is thermally connected to a first connection element SE1, which might be a plug-in element or a screw element. This first connection element is connected to the second end E2 of the cable connection KV. In a further alternative, the temperature sensor 2 is located in a second plug-in element SE2, which is plugged into the first connection-in element SE1.

The first connection element SE1 to which the temperature sensor 1, 2 is connected is a plug/screw element at a connection point within a high-voltage component HK and the plug connection SV1 which is monitored is also located within the high-voltage component.

The first plug connection SV1 includes, for example, a third plug element SE3 and a fourth plug element SE4 which are inserted into each other and the fourth plug element SE4 is directly connected to the first end E1 of the cable connection KV and the third plug element SE3 is part of the high-voltage component,

The second end E2 of the cable connection KV is connected without a plug-in connection to contacts of the first connection element SE1 or is connected to the contacts of the first connection element SE1 via a second plug-in connection SV2, where the second plug connection has a fifth plug element SE5, which is connected to the second end E2 without a plug-in connection, and has a sixth plug element SE6, which is plugged into each other with the fifth plug-in element SE5.

The first end E1 is connected to a high voltage element and is thermally monitored by a temperature sensor 1 or 2 at the opposite end E2 of the cable connection KV, i.e. at a plug connection SV2 connected to the end E2. An element SE2 is screwed together with the connection element SE1, where the elements SE1, SE2 are located at the second end E2 and the temperature sensor is located in at least one of these elements, in order to detect an error at the end E1 or at the connection point there by way of the temperature gradient analysis described here.

The cable connection KV may include a busbar. In some examples, the busbar may include an insulation. The temperature sensor 1, 2 might be a temperature sensor of a contactor of the high voltage component.

A number of implementations have been described. Nevertheless, it will be understood that various modifications may be made without departing from the spirit and scope of the disclosure. Accordingly, other implementations are within the scope of the following claims.

What is claimed is:

1. A method for monitoring a first plug connection at a first end of a cable connection, the method comprising:
detecting a temperature at a second end of a cable connection by a temperature sensor located in a first plug element to which the second end is connected or located in a second plug element, plugged into the first plug element;
determining a temporal temperature gradient from a temporal course of the detected temperature;
comparing the temperature gradient to a threshold value; and
emitting a temperature error signal for the first plug connection when the threshold value is exceeded.

2. The method of claim 1, wherein the method further comprises:
comparing, at a flaw detection unit connected to the temperature sensor, the temperature gradient with the threshold value and to
emitting, from the flaw detection unit, the temperature error signal for the first plug connection when exceeded,
comparing, at a flaw detection unit, the temperature detected by the temperature sensor with a temperature upper limit and to
emitting, from the flaw detection unit, a temperature error signal for the second plug connection if the upper limit is exceeded.

3. The method of claim 1, wherein the first plug element is an electric vehicle charging socket embedded in a vehicle outer shell and accessible from an outside.

4. The method of claim 1, wherein the second plug element is an electric vehicle charging plug.

5. The method of claim 1, wherein the first plug connection comprises a third plug element and a fourth plug element which are inserted into each other and the fourth plug element is directly connected to the first end of the cable connection and the third plug element is part of a high-voltage component, and wherein the third plug element is arranged in a housing of the high-voltage component.

6. The method of claim 1, wherein the second end of the cable connection is connected to contacts of a first plug/screw element without plug-in connection or is connected to the contacts of the first plug/screw element via a second plug connection, wherein the second plug connection has a fifth plug element which is connected to the second end without plug-in connection and has a sixth plug element, which is plugged into each other with the fifth plug element.

7. A method for monitoring a first plug connection at a first end of a cable connection, the method comprising:
detecting a temperature at a second end of a cable connection by a temperature sensor, wherein the temperature sensor is:
located in a first plug element to which the second end is connected, or
thermally connected to a first connection element which is a plug-in element or a screw element, and to which the second end is connected, or
located in a second plug element, plugged into the first plug element;
determining a temporal temperature gradient from a temporal course of the detected temperature;
comparing the temperature gradient to a threshold value; and
emitting a temperature error signal for the first plug connection when the threshold value is exceeded, wherein the cable connection is arranged in a high voltage component.

8. The method of claim 7, further comprising:
comparing, at a flaw detection unit connected to the temperature sensor, the temperature gradient with the threshold value;
emitting, from the flaw detection unit, the temperature error signal for the first plug connection when exceeded;
comparing, at the flaw detection unit, the temperature detected by the temperature sensor with a temperature upper limit; and
emitting, from the flaw detection unit, a temperature error signal for a second plug connection if the upper limit is exceeded

9. The method of claim 7, wherein the first plug element/screw element to which the temperature sensor is connected is a plug/screw element at a connection point within a high-voltage component and the plug connection which is monitored is also located within the high-voltage component.

10. The method of claim 7, wherein the first plug connection comprises a third plug element and a fourth plug element which are inserted into each other and the fourth plug element is directly connected to the first end of the cable connection and the third plug element is part of a high-voltage component, and wherein the third plug element is arranged in a housing of the high-voltage component.

11. The method of claim 7, wherein the second end of the cable connection is connected to contacts of a first plug/screw element without plug-in connection or is connected to the contacts of the first plug/screw element via a second plug connection, wherein the second plug connection has a fifth plug element which is connected to the second end without plug-in connection and has a sixth plug element, which is plugged into each other with the fifth plug element.

12. An error detection unit comprising:
a temperature sensor input;
a gradient former downstream of the temperature sensor input and is set up to determine a magnitude of a temporal variation of a temperature value present at the temperature sensor input;
a gradient comparator which is downstream of the gradient former and is set up to compare a magnitude of change over time with a threshold value and to emit a temperature error signal if the threshold value is exceeded.

13. The error detection unit of claim 12, wherein the error detection unit comprises a temperature comparator downstream of the temperature sensor input and is set up to compare the temperature detected by the temperature sensor with a temperature upper limit and to emit a further temperature error signal when the temperature upper limit is exceeded.
